(19) United States
(12) Patent Application Publication
(10) Pub. No.: US 2006/0230970 A1
(43) Pub. Date: Oct. 19, 2006

(54) Method for patterning of three-dimensional surfaces

(75) Inventors: Juha Pimia, Varkaus (FI); Teppo Heikkinen, Joensuu (FI)

Correspondence Address: VENABLE LLP, P.O. BOX 34385, WASHINGTON, DC, 20045-9998, US

(73) Assignee: PERIOS OYJ, VANTAA (FI)

(21) Appl. No.: 10/516,339

(22) PCT Filed: May 30, 2003
(86) PCT No.: PCT/FI03/00424

§ 371 Date: Apr. 18, 2006

(30) Foreign Application Priority Data
May 31, 2002 (FI) 20021053

(51) Int. Cl. B41F 3/34

(52) U.S. Cl. 101/492

(57) ABSTRACT

A method for patterning of three-dimensional surfaces. The pattern is first formed by printing out a coloring agent on a printing medium. The pattern is transferred to the surface of an object to be patterned. The coloring agent forming the pattern is left unfixed in connection with forming the pattern. The fixing is performed separately with an auxiliary agent applied onto the pattern or with a layer placed on top of the same. The pattern is transferred to the surface of the object to be patterned.

The invention relates to a method for patterning of three-dimensional surfaces according to the preamble of appended claim 1. In this case, patterning refers to the bringing of any two-dimensional image on a surface. In particular, it refers to the decoration of a three-dimensional object surface with a motif which can be a natural image resembling a photo, or a fully abstract pattern, or anything therebetween, made to the customer.

The decoration of various three-dimensional surfaces has become popular in recent years. The purpose of such decoration is also so-called personification, that is, to make the pattern to be placed on the surface personal, wherein the pattern must be custom-made. An alternative for this is to have as large a variety of patterns as possible, wherein the customer can make a selection from a number of alternatives. In this case, the patterns can also be made in serial production, but the series corresponding to one pattern will remain small.

It is known to make a decoration by manual painting. Although even a good precision can be achieved in this way, the work is time-consuming and the cost of work becomes high. For this reason, an aim has been to develop methods whereby the pictorial motif could be transferred to the surface of an object at one time. This also provides the possibility to use the same motifs several times, for example in serial production.

The patterning of three-dimensional surfaces is more or less difficult, depending on the surface topography. It is particularly difficult to pattern the surfaces of such objects whose section is curvilinear (deviating from the straight line) in two planes transverse to each other. The surfaces of such pieces differ from the shape of a cylindrical or conical surface. The decal process is well known in the decoration of cylindrical or conical pieces, and this technology is disclosed e.g. in U.S. Pat. No. 5,948,728. This patent describes a method in which a personified image is formed onto a mug from a photograph by first forming it into a transfer image onto a suitable medium, the pattern included in the transfer image being transferred by means of heat onto the surface of the mug by utilizing known techniques (sublimation dyes).

Furthermore, such methods are known, in which a pattern is formed onto a base paper whereafter lacquer is applied on top of it, and the lacquer and the pattern can be released at a release layer in the base paper by moistening the paper, as disclosed e.g. in U.S. Pat. Nos. 4,529,654 and 4,049,860. These patents do not discuss more closely the special demands caused by surface topography.

It is common to all the above-described techniques that the pattern is first formed on a medium and the pattern is transferred from this medium to the surface of the object to be decorated by means of a transfer method based on the use of either thermally sublimable dyes or a pattern layer releasable from back layers.

Furthermore, Finnish patent application 19992157 and corresponding international publication WO 01/28784 disclose a method for individualized or personalized patterning of the surface of a three-dimensional piece, in which a pattern stored in electrical format is exposed and developed directly onto the surface of the piece. This requires the use of a particular coating (a photosensitive emulsion) on the surface of the piece so that the development of the pattern directly onto the surface of the piece would be possible at all. Such a method requires darkroom technology and special high-precision optics.

European patent 589 984 discloses a method, in which a desired image is formed by a copying machine onto a transfer layer on a base paper, wherein the colouring agents (pigments) forming the image are fixed in their position in the transfer layer during the copying. After this, the transfer layer with the fixed image is detached from the base paper by a wet method. The method is intended for the transfer of copied images onto smooth surfaces, such as glass, porcelain, ceramic, metal, enamel, or plastic surfaces. This publication does not discuss the shape of the surfaces in more detail.

The use of images originally formed by dry copying and dry printing methods for the decoration of surfaces of different shapes causes some problems. The operation of copying and printing devices (e.g. a laser printer) is based, in view of normal use, on the relatively important simultaneous fixing of the image (the fixing of the colouring agent or pigment forming the image in its position in the 2-dimensional plane of the printing medium). For example in a laser printer, the image is fixed in its position on the printing medium by heating the colouring agent (ink) and the medium and by running the medium through heated rollers (so-called Fuser unit). This procedure limits the selection of media which can be generally used for forming the image at the beginning. The fixing of the image also makes it unstretchable. It is true that an attempt can be made later to plasticize the ink film with solvent-based film-forming substances, but this is not possible, for example, with water-based substances forming a protective film. Consequently, the formation of a well-shapeable pictorial motif by dry methods, using colouring agents in powder form, has been impossible.

It is an aim of the invention to present a novel method for the individually made or personified patterning of three-dimensional pieces, whereby a good resolution of the pattern is obtained if necessary, even very difficult surfaces can be patterned which are curvilinear in two directions and which may also have recesses and openings, and by which method it is possible to achieve a pictorial motif which can be stretched better to comply with said shapes. The invention is particularly intended for the patterning of covers of electronic devices, such as mobile phones. The method is suitable for the patterning of the surface of the object both on a single order and in batches of varying size with the same pictorial motif. To attain the above-described aims, the method according to the invention is primarily characterized in what will be presented in the characterizing part of the appended claim 1.

According to the invention, the colouring agent (ink) forming the pattern is left unfixed in connection with forming the pattern, and the fixing is performed separately by means of an auxiliary agent applied onto the pattern.

An essential element in the invention is a film which is elastic-plastic at least at some stage (before the final fixing of the image onto the surface of the object). After the printing stage, the unfixed image is fixed to this film to form such a pattern in which the locations of the different points are defined in the 2-dimensional coordinate system of the film which is still unstreched. The film can be a medium onto which the image has been originally formed by the printing method and onto which it has then been fixed with an auxiliary agent, or it is a film by means of which the unfixed image is taken from a printing medium. Said elastic-plastic film together with the pattern is attached to the surface of a 3-dimensional object. When the film is being placed onto the surface of the object, its elastic-plastic property can be utilized, and it is finally fixed to the surface of the object by a physical method by utilizing, for example, radiation or heat, wherein it can lose its elastic-plastic properties.

The invention comprises the following steps:
a) providing a printing medium,
b) forming a pattern onto the surface of the printing medium by a printing method, in which a colouring agent is applied onto the surface of the printing medium at points determined by the desired pattern, without fixing,
c) fixing the colouring agent forming the pattern by means of an auxiliary agent applied onto it,
d) detaching a 2-dimensional film containing the fixed pattern and the auxiliary agent, from the printing medium, and
e) placing the 2-dimensional film onto the 3-dimensional surface of an object.

According to a second alternative, the invention comprises the following steps:
a) providing a printing medium,
b) forming a pattern onto the surface of the printing medium by a printing method, in which a colouring agent is applied onto the surface of the printing medium at points determined by the desired pattern, without fixing,
c) fixing the colouring agent forming the pattern by means of a 2-dimensional film formed on top of it,
d) detaching the 2-dimensional film together with the fixed pattern from the printing medium, and
e) placing the 2-dimensional film onto the 3-dimensional surface of an object.

The invention has the advantage that when the powder colouring agent (ink) is not fixed by heat during the printing, it is possible to use media whose material or surface material is not limited by the temperatures of the thermal fixing of the printing, and it is thus possible to use a large variety of adhesive films as the printing media or their surface layers. During the printing, the ink is guided onto the medium to the points corresponding to the pattern in the 2-dimensional coordinate system of the medium. The ink remains at these points by means of electrostatic forces between the medium and the powder ink even if the medium were moved, but the pattern can, at this stage, still be broken or “blurred” by touching, for example by sweeping.

By means of a separate auxiliary agent, the pattern can be encapsulated between two stretchable films, of which one is a surface film originating from the printing medium and the other is a film formed by or containing the auxiliary agent. In this context, the fixing of the image does not mean that the physical pattern were unchanged in its 2-dimensional plane but it can now be stretched thanks to the stretchability of the films; however, it can no longer be broken or “blurred” by touching. The pattern remains in its position in relation to the films, and its details become deformed only when the corresponding regions in the film are deformed (stretched).

Furthermore, the alternatives for the protective film to be applied on the pattern are increased. If the pattern is already fixed to the medium, the protective film can be applied as a water-based film-forming substance or by laminating a finished film on top of the pattern. A protective film is formed on top of an unfixed pattern by laminating with a finished film.

In the method according to the invention, an image file corresponding to the pattern is formed by a data processing technique before the pattern is formed on the surface of the medium. On the basis of this image file, the colouring agent is transferred by a suitable printing method, according to the pattern, onto the surface of the printing medium. The pattern can be edited or corrected before the printing while it is in digital format. When laser printing is applied to the transfer and arrangement of the colouring agent onto the surface of the printing medium, the so-called Fuser unit is omitted.

In the following, the invention will be described in more detail with reference to the appended drawings, in which

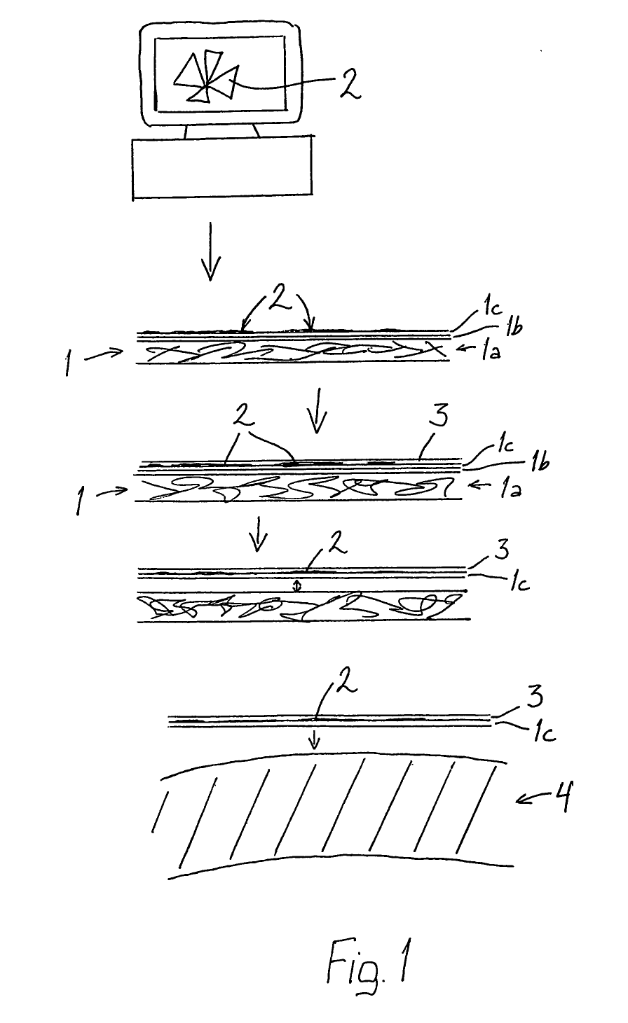

FIG. 1 shows schematically the different steps of the method according to the invention,

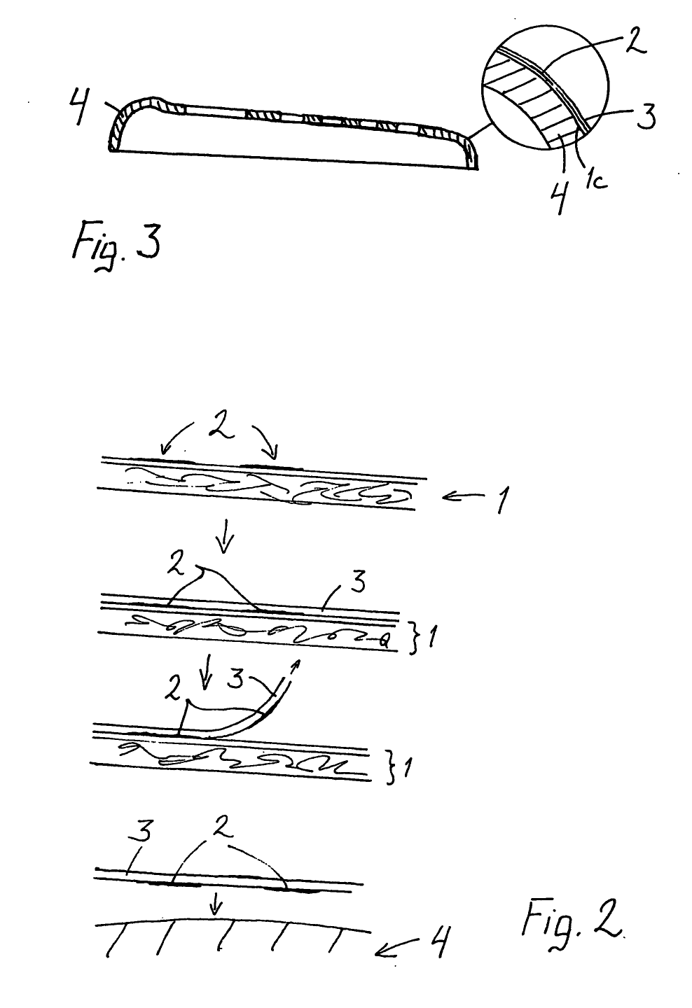

FIG. 2 shows the different steps of an alternative method, and

FIG. 3 shows a cross-section of an object patterned by the method according to the invention.

FIG. 1 shows the method according to the invention in successive steps. First, an image file is formed of the pictorial motif by using a data processing technique. The image file may be generated, for example, with a suitable application program in a computer, for example with a PC. The image may originate from another source, for example it may be originally recorded from an object by the camera technique, or it may have been acquired as an image file via another way. The program can be used to edit the original pictorial motif, for example to take into account the general geometry of the piece to be coated in advance, to minimize distortions, or changes can be made in the pictorial motif itself. Similarly, the pictorial motif can be originally created by the data processing technique.

Before the pattern is applied on the surface of the object, a physical carrier material is needed to implement the transfer. For this purpose, there is a printing medium 1 which can be of a suitable printing paper. The surface of the printing medium 1 can be provided with a film onto which a pattern is formed of a colouring agent and which can be detached from the rest of the printing medium simultaneously when the pattern is detached. The printing medium can also be of a material other than paper, and it can be, for example, a thin plastic film non-resistant to heat.

In the next step, the image 2 is printed out from an image file onto the printing medium 1 by a dry printing method. This printing step can be taken in a colour printer or in another suitable printing device to which the data of the image file can be transferred from the data processor, particularly in a laser printer. For the printing, powder colouring agents known as such are used, which have been previously normally fixed by heat in the fixing unit of the printer. In the printing, the colouring agent is placed onto the surface of the medium 1 in points defined by the image, and it remains temporarily attached to these points primarily by electrostatic forces or other forces, but it is not permanently bound (glued) to the medium 1. Although a laser printer has been discussed above, the unfixed image can also be formed by other means in which a drum or a corresponding means transferring the ink onto the printing medium is activated according to the pictorial motif in such a way that the colouring agent is distributed in points corresponding to the pictorial motif on the surface of the means and is transferred to the printing medium.

In the next step, the pattern 2 is fixed by applying an auxiliary agent by a suitable application method. Onto the surface of the medium 1, where the pattern 2 is located, it is possible, for example, to lightly spray a polymer dissolved in a solvent. After the evaporation of the solvent, the polymer binds the colouring agent present as a fine dust and thereby the corresponding pattern 2. It is also possible to use a solvent only. Thus, the solvents of the auxiliary agent are thus such that they dissolve and sinter the grains of the colouring agent to some extent, wherein the fixing also takes place by means of a phenomenon other than heat but does not blur the image. An example of a solvent mixture which is suitable for such fixing is methyl ethyl ketone/acetone/butyl acetate, which is by no means the only possibility.

Subsequently, it is possible to apply e.g. a water-based protective lacquer which forms a protective layer 3 on top of the pattern 2 and the binding agent. Alternatively, the protective layer 3 can be applied by laminating it as a finished film. The film forming the protective layer 3 is plastic at room temperature (about 20° C.), that is, it is stretchable.

The protective layer 3 can also be provided directly on top of the pattern 2 so that it simultaneously acts as the fixing auxiliary agent. When the fixing of the image and the formation of the protective layer are implemented in the same step, a finished film is used which is laminated on top of the pattern.

After this, the protective film 3 is detached from the medium 1. If the surface of the medium is provided with a suitable surface layer which can be detached from the rest of the printing medium, the pattern 2 remains between two films, the film formed by the surface layer of the medium 1 and the protective film 3. In FIG. 1, the surface layer is indicated with the reference numeral 1c. Such a printing medium is thus provided with a body layer 1a which can be of a suitable base paper or another flexible material which forms a cohesive structure for the printing medium 1 in the printing step. Between the body layer 1a and the surface layer 1c, a release layer 1b can be provided, by means of which the surface layer 1c is detached together with the pattern 2 and the protective film 3. If the aim is to detach the surface layer 1c by means of moisture, the release layer 1b can consist of a suitable water-based polymer, such as polyvinyl alcohol. The material of the surface layer 1c is selected so that the film formed by it is plastic at room temperature (about 20° C.), that is, it is stretchable. The stretchability of the film is preferably more than 100%. The film can be fixed by heat or radiation to its final substrate (the surface of an object).

One advantageous alternative for the material of the film of the surface layer 1c are so-called heat-seal adhesives, which can be activated above a given temperature. The attachment of the film formed of these is thus based on the cross-linking of polymers. However, the material is such that it does not resist to the fixing temperature of the Fuser unit of a printer. The film can be formed of an aqueous dispersion onto a suitable carrier material forming the body layer 1a, and a release layer is not necessarily needed. It is possible to select such a heat-seal adhesive and such a body layer that their adhesion is weak to such an extent that the surface layer can be released mechanically as an integral film together with the image from the body layer by peeling, without a need to form an intermediate third material layer, whose disappearance (e.g. dissolution) would cause the layers to be separated. The body layer can be, for example, paper with a siliconized surface, or a plastic film.

A typical heat-seal adhesive is Lioseal A 8127-21, manufactured by Henkel KgaA, which is known as a water-based heat-seal coating intended for adhesive plastic films. This film also has good stretchability (more than 100%) before its activation.

Finally, the pattern 2 is brought, while lying between the films, onto the object 4 to be patterned and having a three-dimensional surface. At this stage, at which the pattern is positioned in relation to the object 4, the stretchability of the combination film is particularly advantageous. The transfer to the surface of the object can be performed in a jig with a special structure, to which the object 4 is fixed, for example by pressure. Vacuum and pressure can also be used to force off air left between the film and the surface of the object. The pattern 2 will now adhere to the surface of the object 4 through the layer 1c forming the reverse side. If the material of the film 1c on the reverse side is a heat-seal adhesive, the fixing to the surface of the object can be performed by heating above the activation temperature.

When the pattern is heated when it is attached to the object 4, it is also possible to increase the adhesion of the colouring agent to both of the films.

FIG. 2 shows an alternative method in which the principle is the same in other respects but no film is taken along from the printing medium on which the unfixed image was originally formed. Only the protective film 3 is used, which is formed on top of the pattern 2 present on the medium. When the protective film 3 is heated, it simultaneously fixes the image but, after this, it can be mechanically detached from the base. The base can thus be siliconized paper or a corresponding material with a low surface energy. The protective film 3 is then attached to the surface of the actual object to be patterned, wherein the image remains underneath the film.

The protective film 3 forms a final protective layer on top of the pattern 2 on the surface of the object to prevent scratching. FIG. 2 shows a finished coated object 4, exemplified with a plastic cover for a mobile phone.

The protective film 3 can be a suitable lacquer which can be applied in an aqueous state so that when dried, it forms a stretchable film. It is possible to use, for example, UV curable polyurethane lacquers which have a good stretchability (preferably more than 100%). Preferably, the protective layer is formed by first applying the lacquer onto a plastic film, to which the lacquer has poor adhesion and which forms a temporary carrier film for the protective layer 3. By means of this plastic film, the protective layer can be laminated on top of the surface layer 1c (FIG. 1) or on top of the unfixed pattern only (FIG. 2). The protective layer may adhere already by the effect of a sufficient pressure, but slight heating will provide better adherence. The protective layer 3 will be easily released from its carrier film, after which it can be attached with the pattern 2 to the surface of the object and be cured by UV irradiation. One feasible lacquer to form the protective film, to which the invention is not limited, is Bayhydrol 2317, manufactured by Bayer AG.

The invention is not limited to substances or materials itemized above with given trade names or a given chemical composition, but it is possible to use other substances which meet the same requirements. The lacquers to be used may also be other than polyurethane lacquers. Furthermore, it is essential that all the substances to be applied in fluid form onto the surface form a film with internal strength and stretchability, that is, the film formed by the substance can be removed as an integral film and be stretched.

The scope of the invention also covers the idea that the unfixed pattern is first formed on a medium where a layer underneath forms a protective layer. This can be either the whole forming medium or a surface layer which can be detached from the rest of the forming medium. The pattern is thus naturally formed as a mirror image. The fixing can be implemented in an analogical manner. When selecting the materials, one should take into account that the material layer, onto which the unfixed pattern is first formed by printing, is transparent, and the protective layer coming to the other side is used as the layer which fixes the pattern 2 to the surface of the object 4. The pattern can be, for example, printed out onto such a combination film which comprises a film used as a temporary carrier, and a surface layer, which can be e.g. of the above-mentioned UV curable polyurethane lacquer with good stretchability before the curing. The unfixed image is, in turn, covered with a film which also has good stretchability and which is used to attach the pattern 2 and the protective film onto the surface of the object 4. The image can be fixed by means of an auxiliary agent by spraying lightly, after which, for example, the above-described heat-seal adhesive can be applied as an aqueous dispersion. In this way, the pattern 2 can be fixed and encapsulated between two stretchable films. A finished stretchable film can be laminated directly on top of the unfixed image.

The above-mentioned term elastic-plastic should be understood so that the material is stretched without breaking for at least a given distance, preferably more than 100%, and may tend to return elastically to its original length at least partly or may remain in the length to which it has been stretched.

The invention suits particularly well to the patterning of the cover structures of electronic devices, especially the plastic covers of mobile phones. Because the formation of the pattern to be transferred can be made by digital multi-colour printing starting from an image file which can be created in a variety of ways by using motifs from a number of different sources, the invention makes it possible to pattern the surfaces of objects, such as the plastic covers of mobile phones, in a work made on order in series of different sizes, wherein it is possible to speak of so-called “mass personification”.

1. A method for patterning of three-dimensional surfaces, wherein a pattern is first formed by printing a coloring agent on a printing medium, after which the pattern is transferred to the surface of an object to be patterned, wherein the coloring agent forming the pattern is left unfixed in connection with forming the pattern, and the fixing is performed separately by means of an auxiliary agent applied onto the pattern or by means of a layer placed on top of the same, after which the pattern is transferred to the surface of the object to be patterned.

2. The method according to claim 1, comprising:
a) providing a printing medium,
b) forming a pattern onto the surface of the printing medium by a printing method, in which a coloring agent is applied onto the surface of the printing medium at points determined by the desired pattern, without fixing,
c) fixing the coloring agent forming the pattern by means of an auxiliary agent applied onto it,
d) detaching a 2-dimensional film containing the fixed pattern and the auxiliary agent, from the printing medium, and
e) placing the 2-dimensional film onto the 3-dimensional surface of the object.

3. The method according to claim 1, comprising:
a) providing a printing medium,
b) forming a pattern onto the surface of the printing medium by a printing method, in which a coloring agent is applied onto the surface of the printing medium at points determined by the desired pattern, without fixing,
c) fixing the coloring agent forming the pattern by means of a 2-dimensional film formed on top of it,
d) detaching the 2-dimensional film with the fixed pattern from the printing medium, and
e) placing the 2-dimensional film onto the 3-dimensional surface of an object.

4. The method according to claim 1, wherein the 2-dimensional film, with which the pattern is transferred to the surface of the object, is stretchable.

5. The method according to claim 4, wherein the pattern is encapsulated between two stretchable films.

6. The method according to claim 5, wherein one of the stretchable films is a film originating from the printing medium and the other is a film formed by or containing the fixing auxiliary agent.

7. The method according to claim 5, wherein the film originating from the printing medium is placed against the surface of the object to be patterned and the film formed by or containing the fixing auxiliary agent forms an outer protective film.

8. The method according to claim 5, wherein the film formed by or containing the fixing auxiliary agent is placed against the surface of the object to be patterned and the film originating from the printing medium forms an outer protective film.

9. The method according to claim 1, wherein the surface of the object to be patterned is curved in two sectional planes perpendicular to each other and the surface.

10. The method according to claim 9, wherein the object to be patterned is the cover of an electronic device.

11. The method according to claim 1, wherein the method also comprises the forming of an image file corresponding to the pattern by a data processing technique before the image is formed on the surface of the printing medium.

12. The method according to claim 9, wherein the object to be patterned is the cover of a mobile phone.
